(19) United States
(12) Patent Application Publication
(10) Pub. No.: US 2009/0070283 A1
(43) Pub. Date: Mar. 12, 2009

(54) APPARATUS AND METHOD OF CONSTRUCTING USER BEHAVIOR PATTERN BASED ON EVENT LOG GENERATED FROM CONTEXT-AWARE SYSTEM ENVIRONMENT

(75) Inventors: Taegun KANG, Daejeon-city (KR); Aekyeung Moon, Daejeon-city (KR); Rockwon Kim, Daejeon-city (KR); Hyoungsun Kim, Daejeon-city (KR); Hyunkyu Cho, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/058,250

(22) Filed: Mar. 28, 2008

(30) Foreign Application Priority Data
Sep. 11, 2007 (KR) 10-2007-0092136

(51) Int. Cl. G06N 5/00

(52) U.S. Cl. 706/45

(57) ABSTRACT

Disclosed is an apparatus and method of constructing a user behavior pattern based on an event log that is a record of events generated in a context-aware system environment. An apparatus and method of constructing a user behavior pattern based on an event log according to an embodiment of the invention intelligently and actively provides the most applicable service in consideration of a specific user and a location thereof to a user, on the basis of a constructed user behavior pattern.

### CROSS REFERENCE TO RELATED APPLICATION

This application claims the benefit of Korean Patent Application No. 10-2007-0092136, filed on Sep. 11, 2007 in the Korean Intellectual Property Office, the disclosure of which is incorporated herein by reference.

### BACKGROUND OF THE INVENTION

1. Field of the Invention

The present invention relates to generating a user behavior pattern based on an event log. More particularly, the present invention relates to an apparatus and method of constructing a user behavior pattern based on an event log generated from a context-aware system environment.

2. Description of the Related Art

Event logging is a standard method used to record software and hardware events in a computer system. In the computer system, a hardware module or a software module generates events and transmits the generated events to an event logger, which stores the events in a memory. That is, the event log may be a record of a series of operations of processes executed on the computer system.

The event log is mainly used to find out the reason why an error occurs. For example, if the event log is analyzed, it is possible to detect collision between processes, hacking or virus incursion.

In recent years, the event log is also used in compiling statistics, such as the number of times of requests from a user with respect to a specific application or the number of times of accesses from the user with respect to a system. A function of compiling statistics using an event log is particularly useful for a system that provides commercial services for unspecified individuals.

Large Internet shopping malls, such as E-bay or Amazon, use a personalized service providing method. According to the personalized service providing method, the Internet shopping malls analyze purchasing correlations between books for each of the user groups using event logs, and when a user desires to purchase a specific book, the Internet shopping malls recommend another book additionally purchased by a user group that has purchased the corresponding book to the user.

An example of this on-line personalized service providing method is disclosed in Korean Patent No. 420486 (title of invention: SYSTEM FOR PROVIDING NETWORK-BASED PERSONALIZATION SERVICE HAVING ANALYSIS FUNCTION OF USER DISPOSITION). According to the system disclosed in Korean Patent No. 420486, dispositions of individual users who access the Internet websites are analyzed on the basis of information on events generated by the individual users, and a plurality of category data applicable for the dispositions of the individual users are output to computers of the individual users. The system disclosed in Korean Registered Patent No. 420486 is useful for services, such as providing personalized information on on-line and target marketing, at websites that need to provide personalized services, such as large e-commerce websites or portal websites providing information.

Meanwhile, a context-aware system is a system for realizing ubiquitous computing in a predetermined space, such as a home, an office, or the like. It is required for the context-aware system to control all apparatuses in a predetermined space and recognize users and locations of the users therein.

In the context-aware system, a user stores his or her unique information and searches a user terminal that can communicate with the context-aware system. The user terminal has a display unit that displays communication contents with the context-aware system. The context-aware system communicates with the user terminal and recognizes a user and a location of the corresponding user and displays a service applicable for the recognized information to the user. Then, the user selects a desired service on the basis of the displayed information.

For example, in the case where a predetermined structure is separated into a plurality of rooms and printers are installed in a part of the plurality of rooms, if a user desires to use any one of the printers, the context-aware system communicates with the user terminal, recognizes the user and a location of the corresponding user, and informs the user of the location of the printer closest to the user through a display unit of a user terminal.

U.S. Patent Publication No. 2007/0073870A1 discloses a context-aware system that enables a different service to be provided to a user even if the user clicks the same button on a user terminal, according to when the user is at a specific place or where the user exists.

The technology for using an event log in the related art has been used in not only analyzing the reason why an error occurs using the event log but also improving service satisfaction for unspecified individuals who visit specific websites on the basis of purchasing disposition information based on a purchasing history log. However, according to the related art, there is a limitation in that it is not possible to include another history information indirectly associated with specific purchasing, for example, purchasing information obtained from the people around a specific buyer, or purchasing information obtained from another medium like a TV. That is, there is a limitation in that it is not possible to consider all service environments surrounding a specific individual person on an opened broadband network like the Internet in order to improve service satisfaction of the specific individual person.

Since the context-aware system operates in a predetermined space, the context-aware system can provide the first step toward the solution of the above-described problems in the technology for using an event log according to the related art. However, since the context-aware system according to the related art operates under only typical and prescribed conditions of a physical environment surrounding a user, there is a limitation in that it is not possible to provide intelligent and active services that reflects a user execution pattern.

### SUMMARY OF THE INVENTION

Accordingly, the invention has been made to solve the above-described problems, and it is an object of the invention to provide an apparatus and method of constructing a user behavior pattern that is capable of recognizing a user behavior pattern reflecting a disposition of a user in a context-aware system environment varying with time on the basis of an event log, and providing intelligent and active services to the user on the basis of the recognized user behavior pattern.

It is another object of the invention to provide an apparatus and method of constructing a user behavior pattern that is capable of learning a user behavior pattern using an event log for services requested from a user in a context-aware system environment, and providing a service most applicable for the disposition of the user on the basis of the learned user behavior pattern.

In order to achieve the above-described objects, according to an aspect of the invention, there is provided a method of constructing a user behavior pattern based on an event log for events generated in a context-aware system. The method includes creating the event log for the events generated in the context-aware system; extracting a behavior vector from the event log, the behavior vector including information indicating a specific service provided by the context-aware system and information on a user using the specific service as vector elements; and constructing a behavior pattern of the user with respect to the specific service from the behavior vector on the basis of a computer learning theory.

According to another aspect of the invention, there is provided an apparatus for constructing a user behavior pattern based on an event log for events generated in a context-aware system. The apparatus includes an event log creator that creates the event log for the events generated in the context-aware system; a behavior vector extractor that extracts a behavior vector from the event log, the behavior vector including information indicating a specific service provided by the context-aware system, and information at least one of specifying a user using the specific service and information specifying a location of the user using the specific service, as vector elements; and a behavior pattern constructor that constructs a behavior pattern of the user with respect to the specific service from the behavior vector on the basis of a computer learning theory.

The creating of the event log may include collecting the events generated in the context-aware system to create a source event log, and removing an invalid event from the source event log to create a final event log, and the extracting of the behavior vector is extracting the behavior vector from the final event log. Therefore, according to the invention, the user behavior pattern can be constructed easily and quickly by reconstructing the event log such that the user behavior pattern can be analyzed.

The method according to one aspect of the invention may further include recognizing user information and location information of a user from the event log for the events generated in the context-aware system, recognizing the user behavior pattern corresponding to the recognized information, and providing a service corresponding to the recognized user behavior pattern to the user. Therefore, according to the invention, it is possible to intelligently and actively provide a service applicable for a user behavior pattern. A behavior pattern recognizer may transmit the service corresponding to the recognized user behavior pattern to the user terminal so as to allow the user to select a desired service.

The behavior vector may further include information generated by a physical sensor in the context-aware system as a vector element. Therefore, according to the invention, since it is possible to include a physical environment surrounding a user in a user behavior pattern, it is possible to construct a detailed and intelligent user behavior pattern.

The behavior vector may further include information on a command from the user for the events generated in the context-aware system and whether the command is successively executed or not, as a vector element. Therefore, according to the invention, it is possible to construct a detailed and intelligent user behavior pattern.

The computer learning theory may be a nerve network learning theory or a machine learning theory based on a posterior probability distribution analysis. Therefore, according to the invention, it is possible to construct a user behavior pattern on a reliable probable basis.

According to the invention, it is possible to provide an apparatus and method that is capable of extracting a user behavior pattern in a context-aware system environment on the basis of a user behavior vector using an event log.

According to the invention, it is possible to automatically provide to a user an intelligent and active service in consideration of an environment surrounding the user (for example, user and user location), on the basis of a user behavior pattern based on an event log in a context-aware system environment.

According to the invention, it is possible to intelligently and actively provide a service most applicable in consideration of an environment surrounding a user, on the basis of a user behavior pattern that is extracted by analyzing an event log.

### BRIEF DESCRIPTION OF THE DRAWINGS

FIG. 1 is a diagram illustrating a structure of an apparatus for constructing a user behavior pattern according to an embodiment of the invention;

FIG. 2 is a diagram illustrating a structure of a context-aware system according to an embodiment of the invention;

FIG. 3 is an exemplary view illustrating a source event log according to an embodiment of the invention;

FIG. 4 is an exemplary view illustrating a final event log according to an embodiment of the invention;

FIG. 5 is a flowchart illustrating a method of constructing a user behavior pattern according to an embodiment of the invention; and

FIG. 6 is a flowchart illustrating a service providing method according to the method illustrated in FIG. 5.

### DESCRIPTION OF THE PREFERRED EMBODIMENTS

Hereinafter, the preferred embodiments of the invention will be described in detail with reference to the accompanying drawings.

FIG. 1 shows an apparatus 10 for constructing a user behavior pattern according to an embodiment of the invention. Various systems and functional modules including an apparatus 10 for constructing a user behavior pattern (hereinafter, referred to as user behavior pattern constructing apparatus 10), which will be described in the present specification, are implemented by a general hardware structure, such as processors, memories, and I/O devices of a computer system. In this embodiment, for better understanding and convenience of description, the user behavior pattern constructing apparatus 10 is separated from a context-aware system 20. However, it should be understood that the user behavior pattern constructing apparatus 10 may be integrated with the context-aware system 20.

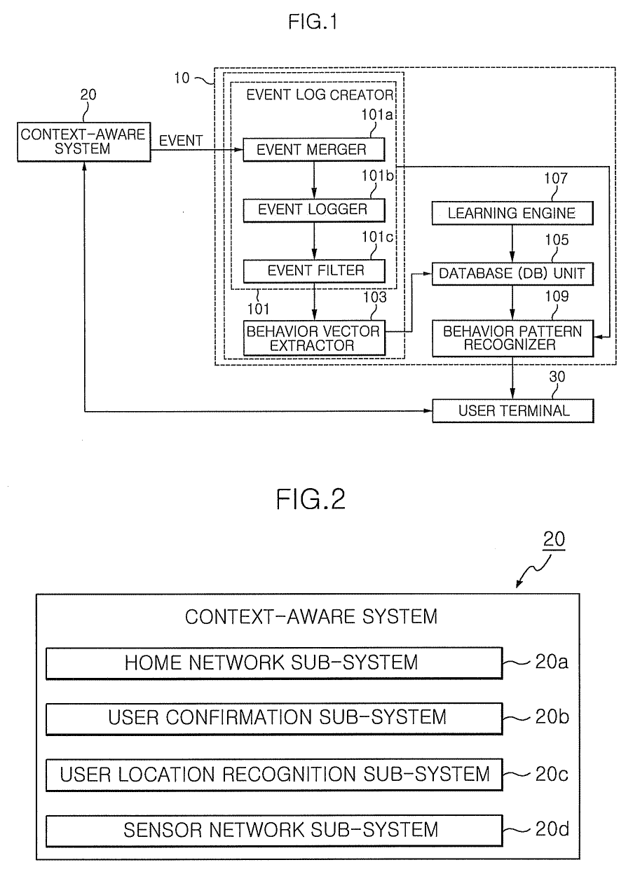

The user behavior pattern constructing apparatus 10 communicates with the context-aware system 20 including four sub-systems 20a, 20b, 20c, and 20d shown in FIG. 2 and a user terminal 30. The context-aware system 20 controls the operations of a plurality of apparatuses according to input from the user terminal 30. The context-aware system 20 suggests a service category applicable for a user or automatically provides services applicable for the user, on the basis of information (for example, information on a user ID and/or a location of the user) obtained from the user terminal 30.

FIG. 2 shows the four sub-systems that constitute the context-aware system 20 according to this embodiment. As the four sub-systems, a home network sub-system 20a controls and manages a plurality of apparatuses, a user confirmation sub-system 20b authenticates an identity of a user, a user location recognition sub-system 20c recognizes a location of a user, and a sensor network sub-system 20d controls and manages a plurality of sensors.

In this case, the home network sub-system 20a is a known system that includes a plurality of home appliances including electronic products used by families, and a home server that integrally controls and manages the plurality of home appliances through wired/wireless communication. The home network sub-system controls the operation of home appliances according to appliance control signals from a user terminal. The home network sub-system may be connected to the Internet or a mobile communication network. In this case, a user who uses the home network sub-system can monitor a situation when at home and/or directly control home appliances when the user is not at home.

The user confirmation sub-system 20b is a known system that includes a user terminal, which is held by a user and stores unique information of the user, and a server that authenticates an identity of the user on the basis of the unique information of the user transmitted from the user terminal.

Examples of the user location recognition sub-system 20c may include all systems capable of recognizing a location of an object in a predetermined zone like a context-aware system environment, for example, a known RF-based location recognition system, an infrared-based location recognition system, and a supersonic-based location recognition system.

The sensor network sub-system 20d as a system for realizing ubiquitous computing is a known system that physically detects the environment in a context-aware system environment using physical sensors, such as a door sensor, a window opening/closing sensor, a gas sensor, a fire sensor, a pressure sensor, a temperature sensor, or the like.

The user behavior pattern constructing apparatus 10 according to this embodiment includes an event log creator 101, a behavior vector extractor 103, and a learning engine 107 as essential elements. The user behavior pattern constructing apparatus 10 may further include a database unit 105 and a behavior pattern recognizer 109. The learning engine 107 constitutes a behavior pattern constructor according to this embodiment. The event log creator 101 may include an event merger 101a, an event logger 101b, and an event filter 101c.

The event merger 101a collects/integrates events generated in the individual sub-systems 20a, 20b, 20c, and 20d of the context-aware system 20 to generate source event logs for the individual sub-systems and transmits the event logs to the event logger 101b.

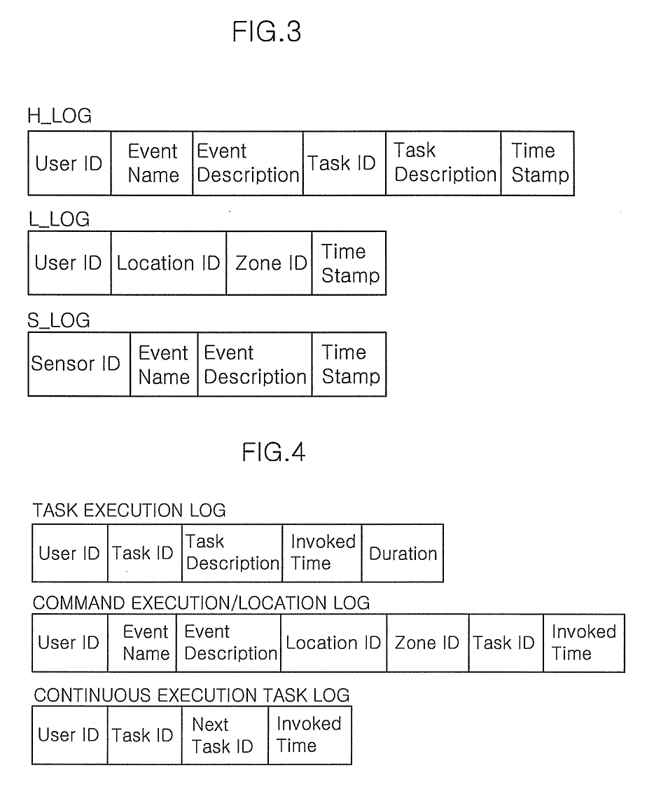

FIG. 3 shows examples of source event logs. An user ID UserId, an event name EventName, an event description EventDescription, a task ID TaskId, a task description TaskDescription, a time stamp TimeStamp, or the like may be recorded in a source event log H_LOG for events that are generated in the home network sub-system. The user ID is an ID assigned to a user that is recognized by the user confirmation sub-system 20b. The event name and the event description are a name uniquely assigned to a corresponding event and a description of the event, respectively. The task ID and the task description are an ID assigned to a specific application of the context-aware system and a description of the task, respectively.

A user ID UserId, a location ID LocationId, a zone ID ZoneId, and a time stamp TimeStamp may be recorded in a source event log L_LOG for events that are generated in the user location recognition sub-system 20c. The location ID is an ID that is assigned to a location of a user recognized by the user location recognition sub-system 20c, and the zone ID is an ID that is assigned to a zone of a user recognized by the user location recognition sub-system 20c. Here, the “location” is a concept that has a larger meaning than the “zone”. The time stamp is information on a time when a location of a user is recognized.

A sensor ID SensorId, an event name EventName, an event description EventDescription, and a time stamp TimeStamp may be recorded in a source event log S_LOG for events that are generated in the sensor network sub-system 20d. The sensor ID is an ID of a sensor that is recognized by the sensor network sub-system 20d.

The event logger 101b stores the source event log transmitted from the event merger 101a in a temporary database unit, and transmits the source event log to the event filter 101c. The event filter 101c removes an insignificant event (for example, normal system start/stop event) or an invalid event (for example, channel conversion event in a state where a TV is turned off) from the source event log so as to generate a final event log, and stores the final event log in the temporary database unit. The event filter 101c is effective in reducing a system processing load.

FIG. 4 shows examples of final event logs according to this embodiment. A task execution log includes a user ID UserId, a task ID TaskId, a task description TaskDescription, an execution start time InvokedTime, and a duration time Duration, and represents a time at which a specific task starts and a duration time for which the specific task is executed, with respect to a specific user. A command execution/location log includes a user ID UserId, an event name EventName, an event description EventDescription, a location ID LocationId, a zone ID ZoneId, a task ID TaskId, and an execution start time InvokedTime, and represents a location (zone) and time at which a specific task for a specific event starts, with respect to a specific user. A continuous execution task log includes a user ID UserId, a task ID TaskId, a next task ID NextTaskId, and an execution start time InvokedTime, and represents when a specific task and a next task are continuously executed, with respect to a specific user. In addition, in order to recognize a user behavior pattern according to a physical environment (light, sound, temperature, motion, or the like), the final event log may include events generated in the sensor network sub-system 20d. The final event log may include all events considered as things that are needed to extract a user behavior pattern.

The behavior vector extractor 103 is driven at a predetermined time interval, and generates a behavior vector including a user object vector and a user location vector on the basis of the final event logs stored in the temporary database unit and stores the behavior vector in the behavior vector database unit 105. The behavior vectors that are stored in the behavior vector database unit 105 are used by the learning engine 107 and the behavior pattern recognizer 109. At this time, the predetermined time interval is set to the time for which data can be sufficiently accumulated to recognize a user behavior pattern and a variation in the user behavior pattern. For example, the predetermined time interval may be set to “one day”.

A user object vector UI_Vector includes vector elements for each user, such as a task executed at a predetermined time interval, a frequency of task execution, and a location of a user. A user location vector UL_Vector includes vector elements for each user location, such as a task executed at a predetermined time interval and a frequency of task execution. Since a user behavior pattern may be changed according to whether or not a command requested from a user is successively executed, the behavior vector may further include vector elements, such as a command requested from a user and whether or not the command is successively executed.

The behavior vector is data on behaviors performed in the past by a user, and is input to the learning engine 107 and the behavior pattern recognizer 109. The behavior vectors may be used in analyzing behaviors from users for every user groups (for example, groups classified by distinction of ages, jobs, or sex).

In addition to the above-described vector elements, the user object vector UI_Vector and the user location vector UL_Vector may further include other vector elements (for example, information detected by physical sensors) considered as things capable of determining a user behavior pattern. In this case, it is possible to extract various and elaborated user behavior patterns by using the learning engine, which will be described in detail below.

The learning engine 107 applies a computer learning theory, such as a known machine learning theory or nerve network learning theory, and analyzes a user behavior pattern on the basis of the user object vector and the user location vector stored in the database unit and constructs the user behavior pattern. For example, in this embodiment, a Bayes net framework is used. The Bayes net enables stochastic casual dependencies between interest entities to be encoded, and enables behavior patterns of non-observed objects to be predicted in a situation where specific data is given. That is, the Bayes net extracts a most likelihood behavior pattern for a given situation on the basis of a posterior probability distribution that is calculated from previously accumulated knowledge.

In this embodiment, on the basis of a probability distribution of services previously used by a user in a context-aware system environment, the learning engine 107 extracts a behavior pattern of the corresponding user from a user object vector. Further, on the basis of a probability distribution of services previously used by users in a specific space in the context-aware system environment, the learning engine 107 extracts user behavior patterns for the corresponding users in the specific space from a user location vector.

For example, when it is determined that it is most likely for a user A to use a service of “utilizing gas range” in a specific time zone on the basis of calculation of a posterior probability distribution from a user object vector by the learning engine 107, the learning engine 107 extracts a behavior pattern of “utilizing gas range” in the specific time zone, with respect to the user A. When it is determined that it is most likely for the user A to use a service of “utilizing gas range” in a specific space (for example, a kitchen) in the specific time zone on the basis of calculation of a posterior probability distribution from a user object vector by the learning engine 107, the learning engine 107 extracts a behavior pattern of “utilizing gas range” with respect to the user A in the specific space (for example, “kitchen”) in the specific time zone.

When it is determined that it is most likely for users in a “living room” in the specific time zone to use a service of “watching TV” on the basis of calculation of a posterior probability distribution from a user location vector by the learning engine 107, the learning engine 107 extracts a behavior pattern of “watching TV” with respect to a user location of “living room” in the specific time zone.

The learning engine 107 may extract behavior patterns on which a variety of vector elements of a behavior vector are reflected. For example, in the case where the vector elements of the behavior vectors that are stored in the database unit 105 further include a vector element of “room temperature information”, when it is determined that it is most likely for a user B to use a service of “working air conditioner” in a predetermined room temperature range at a user location of “living room”, the learning engine 107 extracts a behavior pattern of “working air conditioner” with respect to the user B at the user location of “living room” in the predetermined room temperature range.

The behavior pattern recognizer 109 selects a user behavior pattern, applicable for an event transmitted from the event log creator 101, from user behavior patterns constructed by the learning engine 107. Then, the behavior pattern recognizer 109 suggests a service, which it is most likely for a user to use at the present time in accordance with the selected user behavior pattern, to the corresponding user through the user terminal 30. For example, if a user behavior pattern most applicable in respects to a current user and a location thereof is “watching TV”, the behavior pattern recognizer 109 displays a message of “Do you want to watch TV” on a display unit of a user terminal. Then, the user can execute the corresponding service by simply pressing a “Yes” button. The behavior pattern recognizer 109 does not notify the user terminal 30 of a service category, and the context-aware system 20 may automatically execute the corresponding service.

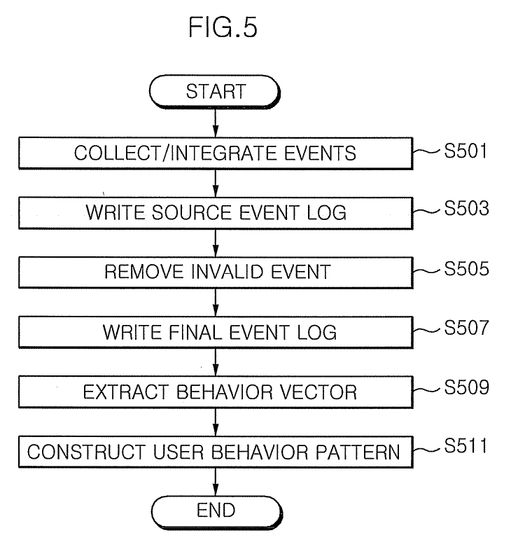

FIG. 5 is a flowchart illustrating a method of constructing a user behavior pattern according to an embodiment of the invention. The event merger 101a collects/integrates events generated in the sub-systems 20a, 20b, 20c, and 20d (Step S501), and creates a source event log (Step S503). The event filter 101c removes an insignificant event or an invalid event from the source event log (Step S505), and creates a final event log (Step S507). The behavior vector extractor 103 extracts a behavior vector for a user ID and a user location from the final event log (Step S509). The learning engine 107 constructs a user behavior pattern from the behavior vector on the basis of a machine learning theory based on the posterior probability distribution (Step S511).

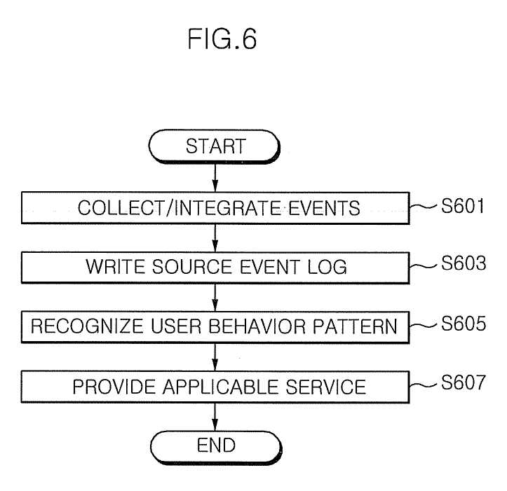

FIG. 6 is a flowchart illustrating a service providing method according to a method of constructing a user behavior pattern shown in FIG. 5. The event merger 101a collects/integrates events generated in the sub-systems 20a, 20b, 20c, and 20d (Step S601), and creates a source event log (Step S603). The source event log is transmitted to the behavior pattern recognizer 109. The behavior pattern recognizer 109 recognizes user ID information and positional information of a corresponding user on the basis of the source event log, and recognizes a user behavior pattern in accordance with the flowchart illustrated in FIG. 5 (Step S605). The behavior pattern recognizer 109 recommends or provides a service applicable for the recognized user behavior pattern to a user (Step S607).

Meanwhile, the invention includes a computer readable recording medium that has a program recorded therein to allow the method of constructing a user behavior pattern to be executed.

Although the exemplary embodiment described above is specified by the specific structure and the drawings, it should be understood that the present invention is not limited by the exemplary embodiment. Accordingly, it will be apparent to those skilled in the art that various modifications and changes may be made without departing from the scope and spirit of the present invention.

1. A method of constructing a user behavior pattern based on an event log for events generated in a context-aware system, the method comprising:
creating the event log for the events generated in the context-aware system;
extracting a behavior vector from the event log, the behavior vector including information indicating a specific service provided by the context-aware system and information on a user using the specific service as vector elements; and
constructing a behavior pattern of the user with respect to the specific service from the behavior vector on the basis of a computer learning theory.

2. The method of claim 1, wherein the information on the user includes information that indicates a specific user using the specific service, and
the constructing of the behavior pattern of the user constructs a behavior pattern of the specific user for the specific service from the behavior vector.

3. The method of claim 1, wherein the information on the user includes information that indicates a specific user using the specific service and information that indicates a specific location of the specific user using the specific service, and
the constructing of the behavior pattern of the user constructs a behavior pattern of the specific user at the specific location with respect to the specific service from the behavior vector.

4. The method of claim 1, wherein the information on the user includes information that indicates a specific location of the user using the specific service, and
the constructing of the behavior pattern of the user constructs a behavior pattern of the user at the specific location with respect to the specific service from the behavior vector.

5. The method of claim 1, wherein the creating of the event log includes collecting the events generated in the context-aware system to create a source event log, and removing an invalid event from the source event log to create a final event log, and
the behavior vector is extracted from the final event log.

6. The method of claim 1, further comprising:
recognizing at least one of information specifying the user and information specifying the user location from the event log for the events generated in the context-aware system, recognizing the behavior pattern corresponding to the recognized information, and providing a service corresponding to the recognized behavior pattern to the user.

7. The method of claim 6, wherein, in the recognizing of at least one of information specifying the user and information specifying the user location, the recognizing of the behavior pattern, and the providing of the service to the user, the service corresponding to the recognized behavior pattern is transmitted to the user terminal so as to allow the user to select a desired service.

8. The method of claim 1, wherein the behavior vector further includes information generated by a physical sensor in the context-aware system as a vector element.

9. The method of claim 1, wherein the behavior vector further includes information on a command from the user for the events generated in the context-aware system and whether the command is successively executed or not as a vector element.

10. The method of claim 1, wherein the computer learning theory is a nerve network learning theory or a machine learning theory based on a posterior probability distribution analysis.

11. An apparatus for constructing a user behavior pattern based on an event log for events generated in a context-aware system, the apparatus comprising:
an event log creator that creates the event log for the events generated in the context-aware system;
a behavior vector extractor that extracts a behavior vector from the event log, the behavior vector including information indicating a specific service provided by the context-aware system, and at least one of information specifying a user using the specific service and information specifying a location of the user using the specific service, as vector elements; and
a behavior pattern constructor that constructs a behavior pattern of the user with respect to the specific service from the behavior vector on the basis of a computer learning theory.
